(19) United States
(12) Patent Application Publication
(10) Pub. No.: US 2020/0217341 A1
(43) Pub. Date: Jul. 9, 2020

(54) LOCKING MECHANISM

(71) Applicant: NOLII LIMITED, London (GB)

(72) Inventors: Asad HAMIR, London (GB); Amar RADIA, London (GB)

(21) Appl. No.: 16/647,389

(22) PCT Filed: Sep. 17, 2018
(86) PCT No.: PCT/EP2018/075106

§ 371 Date: Mar. 13, 2020

(30) Foreign Application Priority Data
Sep. 15, 2017 (GB) 1714932.9

(51) Int. Cl. F16B 5/06; F16M 11/04; F16M 13/00

(52) U.S. Cl. CPC F16B 5/06; F16M 13/005; F16M 11/041

(57) ABSTRACT

A socket (202) of a locking mechanism, the socket comprising: a first end (206) comprising a first opening (200) and a second end (306), the first opening forming a first perimeter (203) of the socket about a socket axis (221), the second opening forming a second perimeter (303) of the socket about the socket axis, the distance between the ends forming a depth (304) of the socket; a first sidewall (308) extending the depth of the socket for a first portion (203A) of the first perimeter; a second sidewall (318) extending from the first end and less than the depth of the socket for a second portion (203B) of the first perimeter, wherein at the second end in line with the second portion of the first perimeter the second end is wider than the first opening of the first end and defines a locking surface (312) perpendicular to the axis of the socket, the surface comprising a locking feature (314) for engaging with a complimentary locking feature (124) of a plug (102).

### TECHNICAL FIELD

The disclosure relates to a locking mechanism for use with a device and is particularly suitable for, but by no means limited to attaching companion accessories to a handheld device.

### BACKGROUND

Many locking mechanisms have been developed to attach handheld electronic devices to companion accessories such as a windscreen mount or bicycle handlebar mount. Such known locking mechanisms typically comprise clamping mechanisms that are not specific to device or accessory dimensions. As a result, such known mechanisms may not enable a secure connection between accessories or devices, and may rely on user setup as to how robust an attachment is provided between handheld device and companion accessory. Other locking mechanisms operate by way of moving parts such as spring-loaded components or snap-fit connections. These mechanisms are prone to deformation and breakage, thereby limiting their useful lifetime. Furthermore, the locking mechanisms tend to be bulky, preventing their use in certain situations or with particular companion accessories, thereby reducing their versatility.

Accordingly, an improved locking mechanism is disclosed to overcome the above drawbacks.

### SUMMARY

According to a first aspect there is provided a socket as defined in Claim 1 of the appended claims. Thus there is provided a socket of a locking mechanism, the socket comprising a first end comprising a first opening and a second end, the first opening forming a first perimeter of the socket about a socket axis, the second opening forming a second perimeter of the socket about the socket axis, the distance between the ends forming a depth of the socket, a first sidewall extending the depth of the socket for a first portion of the first perimeter, a second sidewall extending from the first end and less than the depth of the socket for a second portion of the first perimeter, wherein at the second end in line with the second portion of the first perimeter the second end is wider than the first opening of the first end and defines a locking surface perpendicular to the axis of the socket, the surface comprising a locking feature for engaging with a complimentary locking feature of a plug.

Optionally, the socket further comprising a plurality of the first sidewalls, each extending the depth of the socket for a first portion of the first perimeter, a plurality of the second sidewalls, each extending from the first end and less than the depth of the socket for a second portion of the first perimeter, wherein at the second end in line with each of the second portions of the first perimeter the second end is wider than the first opening of the first end and defines a second perimeter of the socket and a locking surface perpendicular to the axis of the socket, the surface comprising a locking feature for engaging with a complimentary locking feature of a corresponding plug.

Optionally, the socket wherein the locking feature comprises a protrusion from the locking surface.

Optionally, the socket wherein the locking feature comprises a cut-out portion of the locking surface.

Optionally, the socket wherein the first opening comprises a polygon.

Optionally, the socket wherein the polygon has rounded corners.

Optionally, the socket wherein the second perimeter comprises a first portion comprising an arc of the circle formed by the first opening rotating about the socket axis.

Optionally, the socket wherein the second perimeter comprises a second portion comprising a shape complimentary to the corners of the polygon.

Optionally, the socket wherein the first and second portions of the second perimeter are positioned either side of a locking feature.

Optionally, the socket wherein the second perimeter is arranged to compliment a corresponding plug when engaged with the locking feature of the socket.

Optionally, the socket arranged such that a corresponding plug rotates between 25 and 65 degrees to engage the locking feature.

Optionally, the socket of any preceding claim positioned on a handheld device.

Optionally, the socket of any preceding claim positioned on the cover of a handheld device.

Optionally, the socket of any preceding claim wherein the second end comprises a second opening and wherein the second opening is wider than the first opening.

Optionally, the socket wherein the second end comprises a closed end.

According to a second aspect there is provided a plug of a locking mechanism, the plug comprising a first end, a second end, a neck portion extending between the first end and the second end about a plug axis, the second end comprising a locking portion extending radially beyond the neck portion and perpendicular to the plug axis wherein the locking portion comprises a locking surface closest to the neck portion, the locking surface comprising a locking feature for engaging with a complimentary locking feature of a socket.

Optionally, the plug further comprising a plurality of locking features.

Optionally, the plug wherein the locking feature comprises a protrusion from the locking surface.

Optionally, the plug wherein the locking feature comprises a cut-out portion of the locking surface.

Optionally, the plug wherein the locking portion comprises a polygon.

Optionally, the plug wherein the polygon has rounded corners.

Optionally, the plug wherein each locking feature is positioned at or adjacent a polygon corner.

Optionally, the plug wherein the first end is positioned on a handheld device accessory.

According to a third aspect there is provided a locking mechanism comprising a socket of any of claims 1 to 15 and a plug of any of claims 16 to 23.

According to a fourth aspect there is provided a method of manufacturing any of the other aspects, the method comprising providing the socket and/or plug of the other aspects.

Optionally, the neck portion of the plug is integrally moulded with the locking portion of the second end.

Optionally, the neck portion of the plug is a distinct piece from the locking portion of the second end.

Optionally, the neck portion of the plug is integral with the surface of the companion accessory.

With all the aspects, preferable and optional features are defined in the dependent claims.

### BRIEF DESCRIPTION OF THE DRAWINGS

Embodiments will now be described by way of example with reference to the drawings, of which

FIG. 1A illustrates a top view of a plug component on a companion accessory;

FIG. 1B illustrates a side view of a plug component on a companion accessory;

FIG. 1C illustrates a front view of a plug component on a companion accessory;

FIG. 2A illustrates a top view of a socket component on a handheld device cover;

FIG. 2B illustrates a bottom view of the socket component on the handheld device cover of FIG. 2A;

FIG. 2C illustrates a side view of the socket component on the handheld device cover of FIG. 2A;

FIG. 2D illustrates a front view of the socket component of FIG. 2A;

FIG. 2E illustrates a perspective view of a socket component on a handheld device cover, viewed from the front side;

FIG. 2F illustrates a close-up view of the socket of FIG. 2E;

FIG. 3A illustrates a rear view of the socket component on a handheld device cover

FIG. 3B illustrates a perspective rear view of a socket component on a handheld device;

FIG. 3C illustrates a close-up view of the socket of FIG. 3B;

FIG. 4 is a perspective view of a companion accessory with a plug component and a handheld device cover with a socket component, the two components arranged to be locked together, but not yet locked; and

FIG. 5 is a perspective view of a companion accessory with a plug component and a handheld device cover with a socket component, the two components arranged in a locked configuration.

### OVERVIEW

The locking mechanism according to the disclosure comprises a socket, preferably positioned on a device. The socket may comprise part of the device or may comprise part of a case, holder or other attachment means for the device which may be a handheld device. The locking mechanism further comprises a plug arranged to mate with the socket, the plug preferably being situated on or comprising part of a companion accessory to the device.

### DETAILED DESCRIPTION

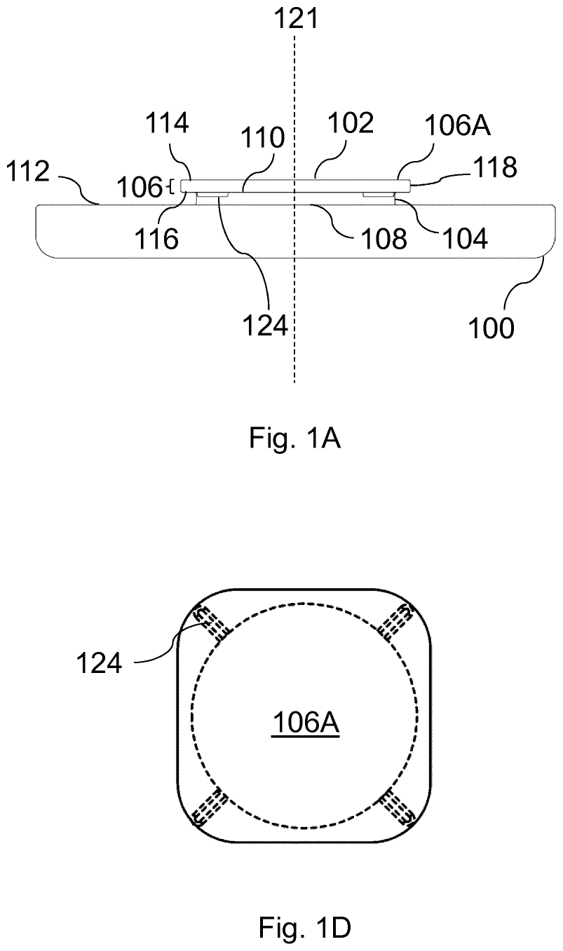

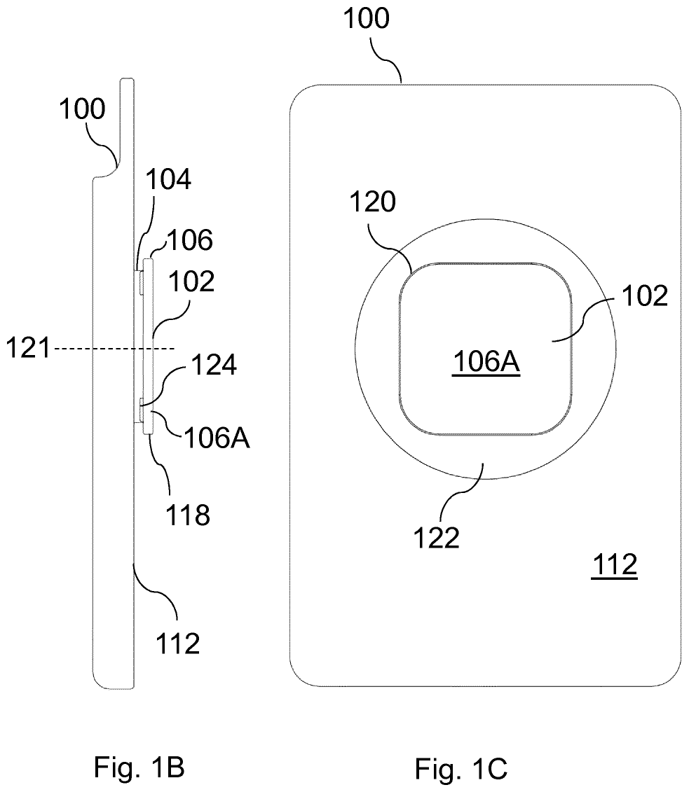

FIGS. 1A-1C illustrate a plug component 102 on a companion accessory to a handheld mobile device or other handheld or portable device. The companion accessory shown is a card wallet, although it will be appreciated that plug component 102 may be attached to any companion accessory. The plug 102 has a neck portion 104, the neck portion having a first end 108 and a second end 110, the first end 108 of the neck attached to a surface 112 of the companion accessory 100 such that the neck portion 104 projects from the surface 112 of the companion accessory 100. The neck portion 104 may be integrally formed with the surface 112 of the companion accessory, or may be attached to the surface 112 of the companion accessory via any known fixing means. The second end 110 of the neck portion comprises a locking portion 106, for example a lock panel 106A, which is preferably integral with the second end 110. The locking portion has a first surface 114 and a second surface 116. The surfaces 114, 116 of the locking portion 106 are on separate planes which may be parallel to each other, and separated by a distance defined by the depth of side wall 118.

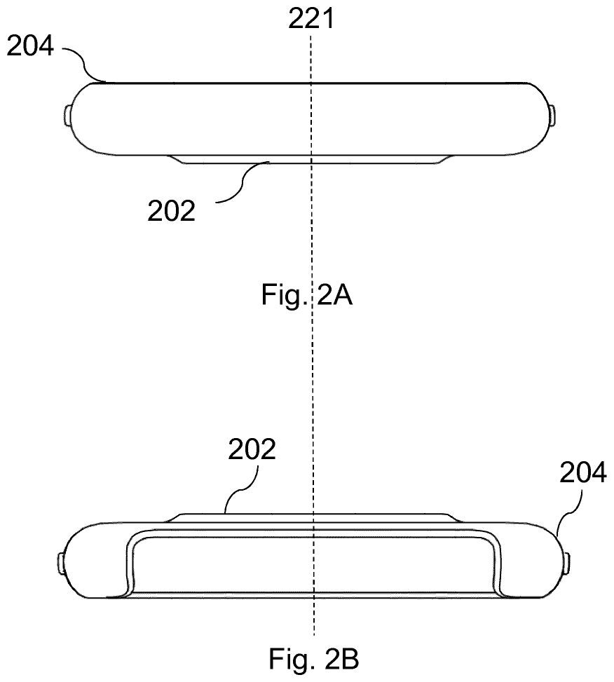

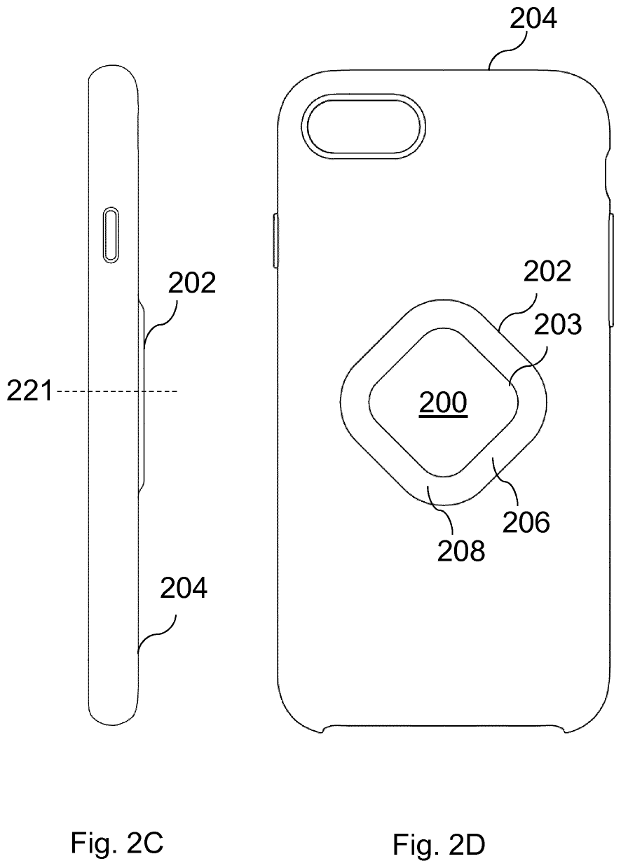

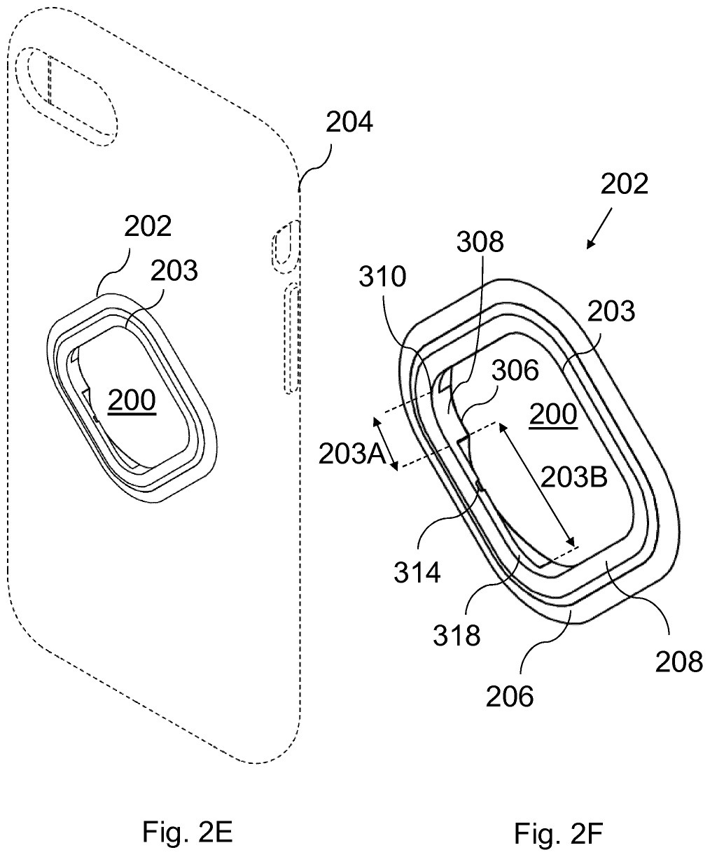

At least one of the first 114 or second surfaces 116 of the locking portion 106 may extend radially beyond the perimeter of the second end 110 of the neck portion and perpendicular to a plug axis 121. In an exemplary embodiment, the locking portion 106 of the plug 102 is shaped to form a polygon with rounded corners 120. The locking portion 106 is arranged to fit into a first opening 200 of a socket 202 (see FIGS. 2D, 2E, 2F discussed later) which may be positioned on a case of a handheld device 204, or directly on the device itself. The radius of the rounded corners 120 on locking portion 106 in the exemplary embodiment is smaller than the radius of the equivalent circle traced by the lock panel 106 when it is rotated about the plug axis 121.

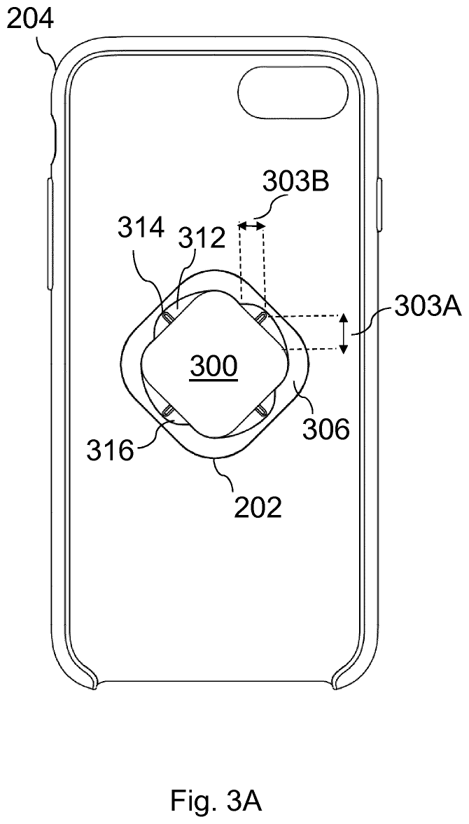

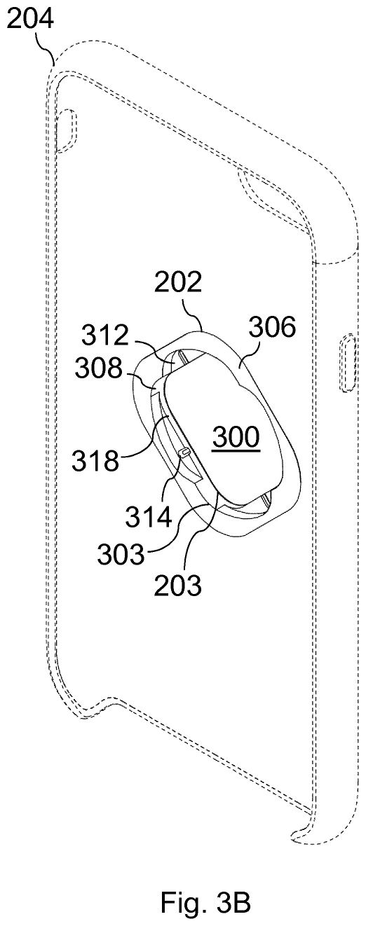

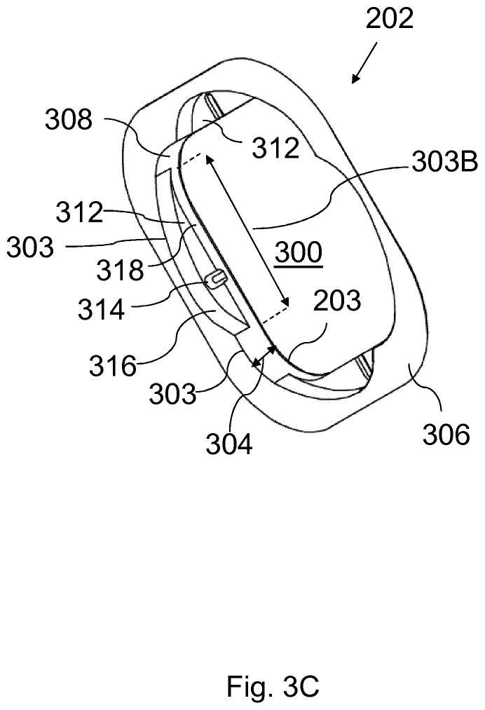

On the second surface 116 which may be termed a locking surface of locking portion 106, or between first 114 and second surfaces 116 depending on their relative sizing, is situated at least one male locking feature 124. Where the locking portion 106 has the shape of a polygon, each locking feature may be positioned at or adjacent a polygon corner. FIG. 3D shows an example of locking feature 124 placement (see through view) on lock panel 106A. Locking feature 124 projects from second surface 116, and may be shaped to form a dome, or a bar with a domed top such that the bar portions of the locking feature hold a corresponding female locking feature in place. The locking feature may be formed of any shape suitable for mating with a corresponding female locking feature. The rounded top of the locking feature aids rotational movement of plug 102 and socket 202 for eventual locking and unlocking of the two components. Locking feature 124 in the exemplary embodiment shown in FIGS. 1A and 1B is located on the second surface 116 of locking portion 106. The at least one locking feature is sized and positioned to mate with a corresponding female locking feature, which is optionally a locking recess or cut-out, in socket 202. The female locking feature may be shaped so as to form an anti-dome to fit the dome shape of male locking feature 124.

In the following description, the figures show a socket comprising a first end comprising a first opening and a second end comprising a second opening. It should be understood that the second end may comprise a closed end. The principles of operation of the socket are the same for both variants. With a closed end, any reference to the plane of the second end should be read as abutment to the closed second end as would be understood.

FIGS. 2A-3C illustrate a socket component 202 on a handheld device or case of a handheld device 204. The socket 202 has a first end 206 comprising a first opening 200 and a second end 306 which may comprise a second opening 300. First opening 200 forms a first perimeter 203 of the socket 202 about a socket axis. Second opening or the second end (closed) 300 forms a second perimeter 303 of the socket about the socket axis 221. The distance between opening 200 and opening/second end (closed) 300 forms the depth 304 (see FIG. 3C) of the socket 202. The first perimeter 203 shares the same shape as the lock panel 106 of plug 102 and is arranged to accept said lock panel 106. Accordingly, the first opening 200 may have the shape of a polygon. The material around the first perimeter 203 on the first end 206 may be slightly thicker relative to the surrounding material at the first end to form a raised border 208 around first opening 200 and first perimeter 203. Said raised border 208 is fashioned from the minimum of material required to ensure a snug fit between plug 102 and socket 202 when locked together, while ensuring that the integrity of all components is maintained with no distortion or breakage. The raised border 208 may for example have a thickness of 2.9 mm which provides the depth of the socket.

The two openings 200 and 300 avoid build-up of dirt and grime inside socket 202 that could otherwise impair the function of the locking mechanism by way of dirt and dust particles collecting in the various recesses of the socket which would be difficult to clean out.

The raised border 208 also reduces damage to surfaces surrounding the first end 206 of socket 202, which may be for example the cover of a handheld device, or a surface 112 of the companion accessory 100 attached to the first end of the neck of plug 102. Such damage could otherwise occur during attachment and removal (twist motion described later) of a companion accessory 100, resulting in scratching of surrounding surface material of either the handheld device or the companion accessory which may be fabricated from a softer material (e.g., silicone or have a rubber coating) than that of the plug and socket (e.g., polycarbonate).

The second opening 300 (or the depth of socket up to the closed end wall) in the second end 306 of socket 202 is also arranged to accept the lock panel 106 of the plug 102, and is larger (wider) than the first opening 200 in first end 206 such that it is arranged to accept the lock panel 106 of the plug 102 when said lock panel 106 is rotated. Said rotation may be between 25 and 65 degrees, for example 45 degrees. Further, any rotation of the lock panel over zero and under 90 degrees may provide the required rotational movement as long as there is enough space provided on the locking surface 312 of the socket (see later) for the locking feature employed.

In FIGS. 2E and 2F it can be seen that at and/or proximal to the rounded corners 310 of socket 202 a first sidewall 308 extends perpendicularly from the first end 206 along the depth of the socket 202 between the raised border 208 and the second end 306 for a first portion 203A of the first perimeter 203 of first opening 200. The first sidewall 308 extending from at and/or proximal to the rounded corners 310 of the socket is arranged to guide corresponding rounded corners 120 on lock panel 106 of socket 102.

A second sidewall 318 having less than the depth of the socket 202 extends from the first end 206 for a second portion 203B of the first perimeter 203. In line with (in axial alignment with) the second portion of the first perimeter, the second opening 300 (or closed end) of the second end 306 is larger (wider) than the first opening 200 of the first end 206. This defines a locking surface 312 perpendicular to the axis of the socket 202, as shown in FIGS. 3A-3C. The locking surface 312 comprises a locking feature 314 for engaging with a complimentary locking feature 124 of a plug. A first portion 303A of the second perimeter 303 adjacent the locking surface 312 comprises an arc of the circle formed by the first opening rotating about it corresponds to an arc of the first opening rotating about the socket axis (in other words, corresponding to the locking panel being rotated about the plug axis) and a second portion 303B of the second perimeter 303 corresponds to an arc of the rounded corners of the lock panel. These portions are either side of the locking feature 124. The depth of the second sidewall 318 corresponds to the length of the neck portion 104 of the plug 102 resulting in a snug fit between the socket 202 and the lock panel 106 when locked together. The length of the preferably integral neck portion 104 together with the depth of lock panel 106 is chosen so as to ensure that when plug 102 and socket 202 are connected, there is frictional contact between the raised border 208 of socket 202 and the surface 112 of the companion accessory 100, and that the first surface 114 of lock panel 106 is flush with the plane of the second end 306 (or abuts the closed second end) of socket 202. An example tolerance of the frictional contact between the raised border 208 and the surface 112 of the companion accessory is 0.0 to 0.5 mm, and preferably 0.0 to 0.1 mm.

This snug, flush arrangement advantageously improves the strength of the attachment between plug 102 and socket 202 when in a locked arrangement, eliminating any instability that would otherwise result in wobbling or rocking of either of the plug 102 or socket 206 and corresponding component accessory or handheld device. Both the x- and y-axes benefit from this strengthened attachment. A slimline arrangement is also maintained. The areas in contact, namely the raised border 208 of socket 202 and the corresponding area 122 contacted by said raised border on the surface 112 of companion accessory 100 provide z-axis support and control, are preferably formed of materials of similar hardness and density, for example hard polycarbonate. This prevents wear of either component as a result of the hardness of the other.

At least one female locking feature 314, which is optionally a recessed or cut-out portion, may be situated on surface 312 in socket 202 and may correspond with protruding male locking feature 124 on lock panel 106. Optionally, the locking features of the plug and socket may be reversed. For example, protruding locking feature 124 may be situated on surface 312 of the socket 202, and corresponding recessed or cut-out portion may be situated on lock panel 106. Either of female locking feature 314 or male locking feature 124 optionally extend perpendicularly to the second sidewall portion 318. In the exemplary embodiment shown in FIG. 3A, four locking features comprising locking recesses 314 are shown on surface 314.

In an exemplary embodiment, the rounded corners 120 of the lock panel 106 of the plug 102 are arranged to abut against corresponding recesses 316 at rounded corners 310 of socket 202.

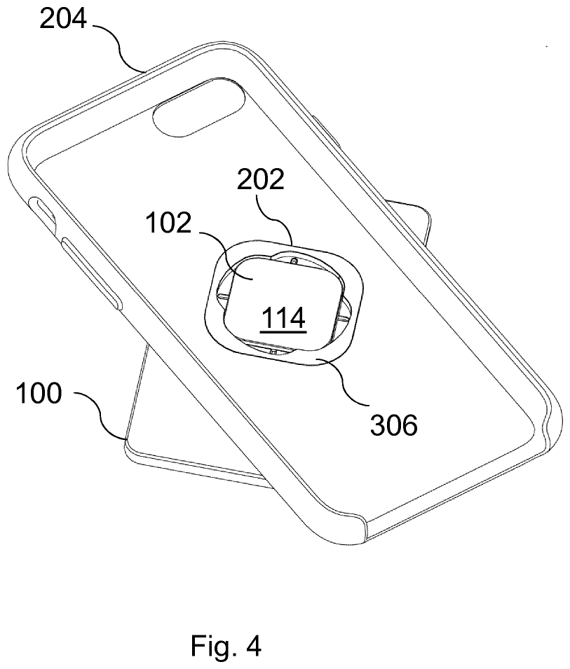

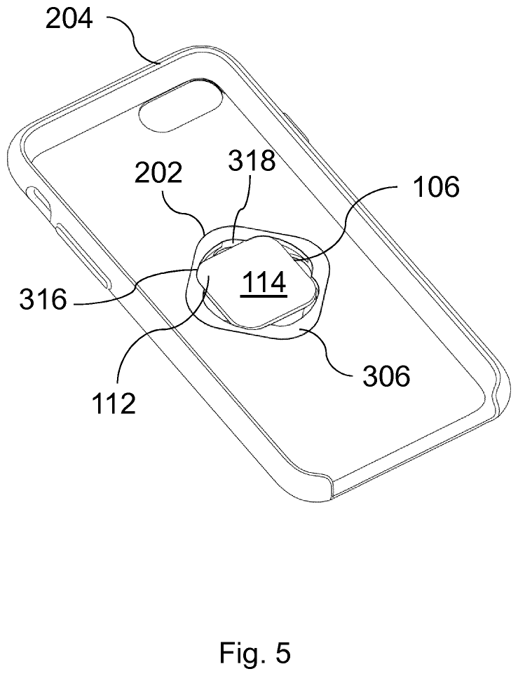

During operation as shown in FIGS. 4 and 5, the lock panel 106 of plug 102 is inserted into the socket 202 until the first surface 114 of lock panel 106 is flush with the plane of the second (open) end 306 or abutting the closed second end of the socket 202. This ensures that the entirety of the depth of the lock panel is inserted into the socket further than the depth of the second sidewall 318 and is able to rotate. The lock panel is then rotated in a camming action in the direction towards the locking surface and about its axis 121 (and the axis 221 of the socket) to reside in a locked configuration between the plug 102 and socket 202. The at least one locking recess 314 is arranged to hold plug 102 by means of interlock with corresponding at least one locking feature 124 of lock panel 106 when plug 102 is rotated into a locked position.

FIG. 4 illustrates a perspective view of an example of the plug 102 and socket 202 in alignment, but not locked. A companion accessory 100 is arranged in the example at 45 degrees to a handheld device cover 204. The lock panel 106 of the plug 102 on the companion accessory 100 is positioned into the first opening 200 of the socket 202 on the handheld device cover 204. The lock panel 106 is positioned such that its rounded corners 120 abut against first sidewall 308 of socket 202. The lock panel 106 is also positioned such that its first surface 114 is flush with the plane of the second end 306 of socket 202.

In FIG. 5 the exemplary plug 102 attached to the companion accessory 100 has been rotated by 45 degrees such that the accessory lies parallel with the handheld device cover 204. The first surface 114 of lock panel 106 is flush with the plane of the second end 306 of the socket 202. Upon rotating the companion accessory 100, the rounded corners 120 of the lock panel 106 of plug 102 proceed in a camming movement along the second perimeter 303 of the second opening until abutment against curved recesses 316 of the socket corresponding to the rounded corners 120 of the plug 102. The lock panel 106 is held in a locked arrangement within the socket 202 by virtue of the at least one locking feature 314, which is optionally a recess, on surface 312 of socket 202. During the relative rotation of the plug 102 and socket 202, protruding locking feature 124 is aligned with and snaps into corresponding recessed locking feature 314, thereby locking plug 102 and socket 202 together.

The locking mechanism is released by rotating the plug 102 and socket 202 in the opposite direction to that required for locking, thereby releasing the frictional hold between the locking features 314 and 210. The plug 102 and socket 202 are then separated by aligning lock panel 106 with the first opening 200 on the first end of the socket, and removing said lock panel 106 via said first opening 200 through which it entered socket 202.

It will be appreciated that the socket 202 and plug 102 can be made of any appropriate material. For example, both parts can be made of a hard polycarbonate (PC) core, or of a PC core and over moulded silicone, although other materials or material combinations may be used. The use of a hard material such as PC maintains the shape and avoids distortion of components. Any hard material such as acrylic or polypropylene may be used. The handheld device with the socket as shown in the exemplary embodiments is fabricated from a hard core of PC which may comprise the entire or a portion of the case of the device to give stability and over moulded with a softer material such as silicone on the first surface and sides to create a smooth feel for the user as well as providing protection. The inside of the case fashioned to abut against the surface of a handheld device may be coated with a microfibre textile to advantageously protect and secure said surface as well as well as provide additional cushioning and scratch resistance, although said microfibre textile may not extend to the area around the locking socket. The use of any of the aforementioned materials is both exemplary and optional, and any appropriate material may be used.

The locking mechanism according to the disclosure presents several advantages over existing locking mechanisms. In particular, the locking mechanism has no moving parts, thereby increasing the useful lifetime of both the plug and socket. The locking mechanism is also compact and slimline, thus is arranged to cause little to no disruption to a user when implemented on devices and companion accessories. As such, the locking mechanism is robust and versatile.

While the plug and socket combination described above is referred to in the exemplary embodiments and figures as being arranged to have a plug with a lock panel having a square shape with rounded corners and corresponding openings and recesses to accept said shape, it will be appreciated that other shapes of lock panel and corresponding openings and recesses, such as but not limited to triangles or hexagons, or any polygon may be used. Any shape that incorporates at least one locking element for use in a socket of a corresponding shape with at least one corresponding locking recess may be used.

The size and shape of the locking elements and corresponding locking recesses is not limited to the dome and anti-dome of the exemplary embodiments and other sizes and shapes may be used. The number of locking elements and locking recesses may also increase or decrease depending on the shapes and materials used. The materials of said locking elements and corresponding contact areas on the lock panel may also vary.

The exemplary embodiments and figures refer to the socket being part of a phone cover for a handheld device and the plug being part of a companion apparatus for attachment thereto. It will be appreciated that this is not a limiting feature and the socket and plug may be integrally formed with or fabricated for attachment to any other portable system for use with a companion apparatus, including but not limited to sport bands, card wallets, battery attachments, bicycle handlebar attachments, car docking systems, etc. The plug and socket may be interchanged such that the plug is attached to a mobile/portable/handheld device and the socket is attached to a companion accessory. Alternatively, in the case of a bicycle handlebar attachment or a car dock, one of the plug or socket may be attached to a further attachment means for coupling with the bicycle handlebars or car windscreen, for example a handlebar clamp or windscreen sucker arrangement.

1. A socket of a locking mechanism, the socket comprising:
a first end comprising a first opening and a second end, the first opening forming a first perimeter of the socket about a socket axis, the second opening forming a second perimeter of the socket about the socket axis, the distance between the ends forming a depth of the socket;
a first sidewall extending the depth of the socket for a first portion of the first perimeter; and
a second sidewall extending from the first end and less than the depth of the socket for a second portion of the first perimeter, wherein at the second end in line with the second portion of the first perimeter the second end is wider than the first opening of the first end and defines a locking surface perpendicular to the axis of the socket, the surface comprising a locking feature for engaging with a complimentary locking feature of a plug.

2. The socket of claim 1 further comprising:
a plurality of the first sidewalls, each extending the depth of the socket for a first portion of the first perimeter; and
a plurality of the second sidewalls, each extending from the first end and less than the depth of the socket for a second portion of the first perimeter, wherein at the second end in line with each of the second portions of the first perimeter the second end is wider than the first opening of the first end and defines a second perimeter of the socket and a locking surface perpendicular to the axis of the socket, the surface comprising a locking feature for engaging with a complimentary locking feature of a corresponding plug.

3. The socket of claim 1 wherein the locking feature comprises a protrusion from the locking surface.

4. The socket of claim 1 wherein the locking feature comprises a cut-out portion of the locking surface.

5. The socket of claim 1 wherein the first opening comprises a polygon.

6. The socket of claim 5 wherein the polygon has rounded corners.

7. The socket of claim 1 wherein the second perimeter comprises a first portion comprising an arc of the circle formed by the first opening rotating about the socket axis.

8. The socket of claim 5 wherein the second perimeter comprises a second portion comprising a shape complimentary to the corners of the polygon.

9. The socket of claim 7 wherein the first and second portions of the second perimeter are positioned on either side of a locking feature.

10. The socket of claim 7 wherein the second perimeter is arranged to compliment a corresponding plug when engaged with the locking feature of the socket.

11. The socket of claim 1 arranged such that a corresponding plug rotates between 25 and 65 degrees to engage the locking feature.

12. The socket of claim 1 positioned on a handheld device.

13. The socket of claim 1 positioned on the cover of a handheld device.

14. The socket of claim 1 wherein the second end comprises a second opening and wherein the second opening is wider than the first opening.

15. The socket of claim 1 wherein the second end comprises a closed end.

16. A plug of a locking mechanism, the plug comprising:
a first end;
a second end; and
a neck portion extending between the first end and the second end about a plug axis;
the second end comprising a locking portion extending radially beyond the neck portion and perpendicular to the plug axis; wherein
the locking portion comprises a locking surface closest to the neck portion, the locking surface comprising a locking feature for engaging with a complimentary locking feature of a socket.

17. The plug of claim 16 further comprising a plurality of locking features.

18. The plug of claim 16 wherein the locking feature comprises a protrusion from the locking surface.

19. The plug of claim 16 wherein the locking feature comprises a cut-out portion of the locking surface.

20. The plug of claim 16 wherein the locking portion comprises a polygon.

21. The plug of claim 20 wherein the polygon has rounded corners.

22. The plug of claim 16 wherein each locking feature is positioned at or adjacent a polygon corner.

23. The plug of claim 16 wherein the first end is positioned on a handheld device accessory.

24. A locking mechanism comprising a socket of claim 1.
